(19) United States
(12) Patent Application Publication
(10) Pub. No.: US 2024/0395286 A1
(43) Pub. Date: Nov. 28, 2024

(54) SOUND SYNC ON VIDEO MONTAGES

(71) Applicant: Snap Inc., Santa Monica, CA (US)

(72) Inventors: Marc Brown, New York, NY (US); Shuaiqing Luo, Los Angeles, CA (US); Matthew Mahar, San Francisco, CA (US); Anton Shevchenko, Black Diamond, WA (US); Yin Tang, Los Angeles, CA (US)

(21) Appl. No.: 18/484,326

(22) Filed: Oct. 10, 2023

Related U.S. Application Data
(60) Provisional application No. 63/504,748, filed on May 28, 2023.

(51) Int. Cl. G11B 27/031

(52) U.S. Cl. CPC G11B 27/031

(57) ABSTRACT

A video montage is assembled by one or more processors by selecting a number of media items for use in the video montage from a collection of media items. An audio track having a theme parameter corresponding to a theme parameter of the number of media items is identified, and a video montage incorporating the media items and the audio track is generated. A data structure may specify an identity and order of the media items and a start location of the audio track, and the video montage may be created by generating individual video segments from each media item in the number of media items, and assembling the individual video segments into the video montage based on an order specified in the data structure. Updates or edits to the video montage are represented as changes to the data structure, which is used to generate an updated video montage.

### RELATED APPLICATION DATA

This application claims the benefit of U.S. Provisional Patent Application Ser. No. 63/504,748, filed on May 28, 2023, the contents of which are incorporated herein by reference as if explicitly set forth.

### BACKGROUND

Social interaction applications provide a vehicle for the sharing of user content such as photos or videos. In some instances, the photos or videos may be supplemented by augmented reality or other effects that are generated live on a camera feed and displayed on the display of a mobile device for preview. The user may be able to select and manipulate effects to apply to the live camera feed, and when satisfied capture an image or record a video including the effects. The captured video or photo can then be shared on the social networking platform. Photos can easily be edited after capture, but it is desirable to provide additional options for enhancing, editing or presenting captured or stored videos and photos.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a messaging system that has both client-side and server-side functionality, according to some examples.

FIG. 3 is a diagrammatic representation of a data structure as maintained in a database, according to some examples.

FIG. 4 is a flowchart showing video montage creation operations according to some examples.

FIG. 5 is a flowchart showing video montage updating and editing operations according to some examples.

FIG. 6 is a flowchart showing video montage updating and editing operations according to some examples.

FIG. 7 is a diagrammatic representation of a machine in the form of a computer system within which a set of instructions may be executed to cause the machine to perform any one or more of the methodologies discussed herein, according to some examples.

FIG. 8 is a block diagram showing a software architecture within which examples may be implemented.

### DETAILED DESCRIPTION

Disclosed herein are examples of the creation of shareable content in the form of a video montage with an audio track. The video montage comprises short video segments that have either been obtained from longer videos captured or stored by the user, or that are generated from images captured or stored by the user. Each video segment has a length that is based on a number of the beats of the audio track so that transitions between video segments is synchronized with the beats of the audio track. The video montage is created by assembling the video segments together and adding the audio track to the video montage such that a beat of the audio track coincides with the start of first video segment.

In some examples, the audio track is selected based on an associated theme, for example Christmas music for a Christmas-themed video montage, birthday music for a birthday video montage, beach-themed music for a beach vacation video montage, and so forth. For example, the theme can be a search term used to find relevant videos or images for use in the montage. In another example, the video montage is based on items that have been recently added to the device's “camera roll,” or based on a particular time period such as “this time last year” or “this time last month.” In this example, the system determines a theme or a mood from the data characterizing the media items that are associated with, or have been determined for, the media items.

### Networked Computing Environment

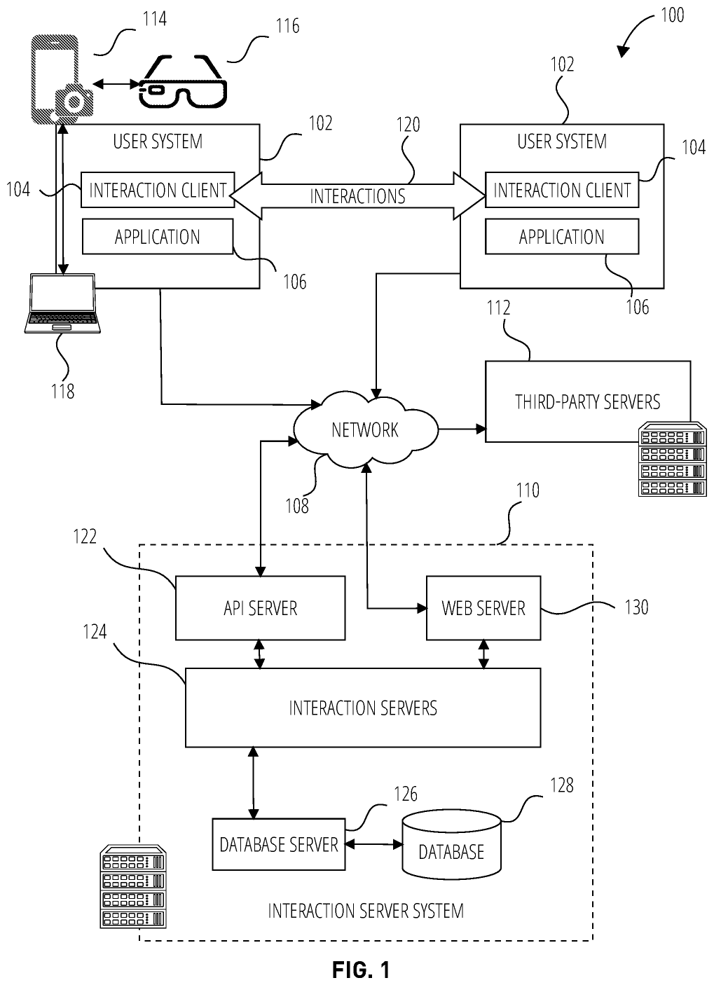

FIG. 1 is a block diagram showing an example interaction system 100 for facilitating interactions (e.g., exchanging text messages, conducting text audio and video calls, or playing games) over a network. The interaction system 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, or other user device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, user device information, geolocation information, media augmentation and overlays, message content persistence conditions, entity relationship information, and live event information. Data exchanges within the interaction system 100 are invoked and controlled through functions available via user interfaces (UIs) of the interaction clients 104.

Turning now specifically to the interaction server system 110, an Application Program Interface (API) server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the interaction servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the interaction servers 124. The Application Program Interface (API) server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity relationship graph (e.g., the entity graph 310); the location of friends within an entity relationship graph; and opening an application event (e.g., relating to the interaction client 104).

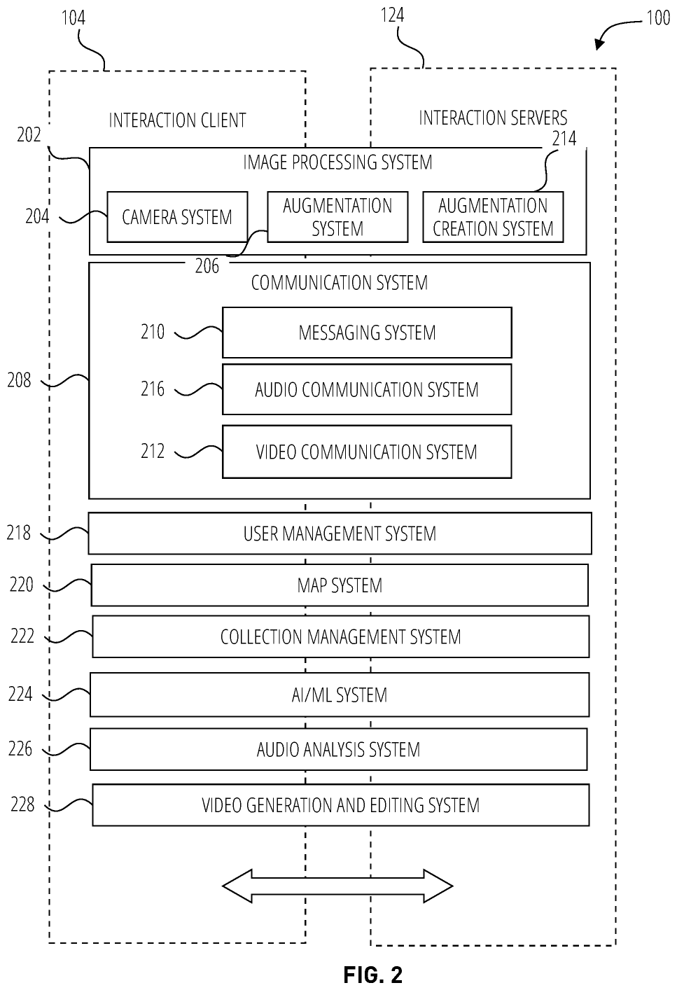

The interaction servers 124 host multiple systems and subsystems, described below with reference to FIG. 2.

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the interaction system 100.
Service discovery: Microservice subsystems may find and communicate with other microservice subsystems of the interaction system 100. Service discovery mechanisms enable microservice subsystems to locate and communicate with other microservice subsystems in a scalable and efficient way.
Monitoring and logging: Microservice subsystems may need to be monitored and logged in order to ensure availability and performance. Monitoring and logging mechanisms enable the tracking of health and performance of a microservice subsystem.

In some examples, the interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and augment (e.g., annotate or otherwise modify or edit) media content associated with a message.

A camera system 204 includes control software (e.g., in a camera application) that interacts with and controls hardware camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory 706 of a user system 102. These augmentations are selected by the augmentation system 206 and presented to a user of an interaction client 104, based on a number of inputs and data, such as for example:
Geolocation of the user system 102; and
Entity relationship information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system) that, based on duration and display parameters associated with a message or collection of messages (e.g., a story), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 308, entity graphs 310 and profile data 302) regarding users and relationships between users of the interaction system 100.

A map system 220 provides various geographic location (e.g., geolocation) functions and supports the presentation of map-based media content and messages by the interaction client 104. For example, the map system 220 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A collection management system 222 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 222 may also be responsible for publishing an icon that provides notification of a particular collection to the user interface of the interaction client 104. The collection management system 222 includes a curation function that allows a collection manager to manage and curate a particular collection of content. For example, the curation interface enables an event organizer to curate a collection of content relating to a specific event (e.g., delete inappropriate content or redundant messages). Additionally, in conjunction with the artificial intelligence and machine learning system 224 and audio analysis system 226, the collection management system 222 employs machine vision (or image recognition technology) and content rules to curate a content collection automatically, In certain examples, compensation may be paid to a user to include user-generated content into a collection. In such cases, the collection management system 222 operates to automatically make payments to such users to use their content.

The collection management system 222 scans for, assigns and, in certain causes edits to, videos and photos for use in a video montage, based on a number of rules, and pairs an audio track for use with the montage. In some examples, the collection management system 222 also initiates scanning of available photos and videos, either stored locally on the user system 102 or remotely in the databases 128 of the interaction system 100, or on a third-party server 112, to initiate the generation of a beat-matched video montage as described herein. In some examples, the collection management system 222 accesses existing metadata about the videos, photos and audio tracks stored or maintained in various collections, or generates new or supplementary metadata for these media items by using the functionality of the artificial intelligence and machine learning system 224.

In some examples, the scanning of a media collection comprising photos or videos, such as a “camera roll” present in the local memory of the user system 102 is initiated based on the detection of a certain number of new photos or videos that have been captured or stored by a user of the user system 102, or based on the user initiating the scanning of one or more media items in the existing collection. In some examples, the scanning is provided based on intervals or dates (e.g., once a week, once a month) or on location information, for example based on the user system 102 being or having been at a vacation destination. Additionally, scanning of media items can be initiated from the interaction server system 110 or the interaction client 104 based on events or promotions initiated by the host of the interaction system 100. The user can also choose particular photos and videos for inclusion in a video montage generated by the collection management system 222. In further examples, the photos and videos are taken from a timeline or “story” posted by the user on the interaction server system 110 or social media platform. Finally, the creation of a new video montage can occur once the video analysis and editing system 214 determines that a sufficient amount of new media is available since the last time a video montage was created.

In some examples, the scanning and selection of photos or videos from the available photos or videos is be based on a particular theme and the theme is based on various factors. Some example factors include a time of the year, such as a holiday season or a particular location, such as at a beach resort. Other example factors include factors based on knowledge of the user, such as pet ownership, hobbies, interests, religious affiliation, the use of a particular filter, or based on a theme or mood specified by the user.

In some examples, the selection of an audio track for use in the video montage is based on the associated theme, such as Christmas music for a Christmas-themed video montage, birthday music for a birthday video montage, beach-themed music for a beach vacation montage, and so forth. In the event that a particular theme or category has not been used, such as when the video montage is based on items that have been recently added to the camera roll, or when the video montage is based on a particular time period such as “this time last year” or “this time last month,” the collection management system 222 determines a theme or a mood from the data characterizing the media items that are associated with or have been determined for the media items.

For example, if the media items to be used in the video montage are primarily landscapes or nature scenes, a tranquil audio track can be selected, while if the media items are night scenes in a city, an upbeat electronic dance track can be selected. Similarly, if the media items have been tagged or characterized as beach or holiday-season media items, beach or holiday-themed music can be selected by the collection management system 222 for use in the video montage. Furthermore, if the media items have a certain mood or tone as determined by the color palette, brightness or other quality, such as sunny or rainy weather depicted in the image or video, a more bright/upbeat or somber/downbeat audio track can be selected, respectively.

In some examples, the images are processed by an image-to-text (image annotation) component or video-to-text (video annotation) component that generates descriptions and characterizations of images or videos and of objects or people portrayed in the images or videos. The image annotation and video annotation components can extract both visual features and semantic concepts. The output of the image or video annotation component for each media item can be saved as “tags” or metadata, which can then be used to select or group photos or videos based on common characteristics. In some examples the image and video annotation components are Convolutional Neural Networks (CNNs), Recurrent Neural Networks (RNNs), Deep Neural Networks (DNN) based on AIA, iv) Long-Short-Term Memories (LSTMs) and so forth, as is known in the image and video annotation arts.

Similarly, if the media items have a common or similar augmentation, such as an image filter, the use of this common or similar augmentation can be used to characterize the media items based on descriptors or tags associated with the particular augmentation. For example, if the image filters have been used that have a common cat theme, in which cat ears, whiskers and so forth are applied to a representation of an individual, or augmentations that are applied to images of cats, then a cat theme can be used to characterize or search for media items to include in the selection of media items for use in the montage, and a cat-related audio track, such as from the musical Cats, can be selected for use with the montage.

In some examples, the theme of the song is determined from or corresponds to the song's metadata, including a genre, mood, emotion, BPM, key, user rating and so forth. Also, the text of a song's lyrics can be characterized, or primary words or phrases extracted therefrom, for use in determining the theme or otherwise characterizing the audio for selection, or for use in refining the selection.

As used herein the term “theme parameter” refers to a specific and distinctive quality, characteristic, or concern, or distinctive atmosphere or context of a visual media item that can be determined or inferred from the visual media item. Various examples of which (themes, moods, visual tones, emotions expressed by participants, characteristics of an augmentation that has been applied to the media item, and so forth) can be used to select or characterize media items.

In some examples, the collection management system 222 manages or accesses a collection of data that might be independent from the interaction client 104 as such. For example, in the case of user systems 102 such as smartphones or tablets, a “camera roll” of images and videos captured by the camera system 204 is maintained by the operating system of the user system 102 in the local memory of the user system 102 and is available to any application 106 on the user system 102 that has the appropriate permissions. In some examples, the collection management system 222 makes changes to the images or videos, such as for example editing media items, deleting media items and editing metadata associated with media items. In other examples, the collection management system 222 maintains a database of metadata retrieved from, associated with, or derived from the media items in the camera roll.

Since changes to the camera roll may be made by other applications 106 that are independent of the interaction client 104, the collection management system 222 periodically scans the camera roll to determine if any media items have been edited, added to or deleted from the camera roll. In some examples this occurs every time the interaction client 104 is started, but this can occur periodically when the interaction client 104 is active. In other examples, the interaction client 104 subscribes to update notifications from the camera system 204. Additions to or deletions from the camera roll camera taking place via the interaction client 104 itself will be tracked directly by the collection management system 222.

The collection management system 222 also generates and maintains data structures that defines how a video montage is to be or has been created. The data structure identifies the audio track associated with the video montage, the starting point of the audio track, the interval between transitions between media items, the number and identity of media items in the video montage, and the order of the media items in the video montage. For video media items, the starting point in the video media item as used in the montage is also stored. The number of media items can be, for example, between 3 and 20 and the duration between transitions can be between 1.5 and 3 seconds. In some examples the transitions are selected to be a duration that is an integer number of beat periods of the corresponding audio track. The data structure is used by the video generation and editing system 228 to generate a video file using the identified audio track and identified media files from the camera roll.

When the collection management system 222 determines that a media item has been deleted from the camera roll or deletes an item from the camera roll itself, it scans the data structures underlying existing video montages to determine if the deleted media item has previously been used to generate an existing video montage. If so, the collection management system removes the identifying information of the deleted media item from the data structure corresponding to that video montage. In some examples, to replace the deleted media item in the video montage, the collection management system 222 then scans the database of metadata retrieved from, associated with, or derived from the media items in the camera roll to identify a media item having similar characteristics to those making up the particular video montage, and replaces the data identifying of the deleted media item in the data structure with the data identifying the new media item. The collection management system 222 then instructs the video analysis video generation and editing system 228 to regenerate the video montage file using the updated data structure that includes an identification of the replacement media item. The collection management system 222 then replaces the original video montage file with the updated video montage file. This updating of the video montage files based on updates to the camera roll ensures that media items that have been deleted by the user never appear in video montages.

An audio analysis system 226 provides analysis of audio tracks in certain cases described herein. In particular, the audio analysis system 226 uses transient detection to identify the timestamp of a starting beat for use in pairing a song with a collection of visual media items as described herein, as well as determining the beats per minute of the audio track, which can then be used as described herein for automatically synchronizing the presentation of visual media items with the beat of the audio track. The beats per minute of the audio track may for example be converted to a beat period (e.g., the time in seconds between each beat), which together with the timestamp of the starting beat, can be used to generate a beat grid that can be used to synchronize the presentation of visual media items with the beat of the audio track. Alternatively, beats per minute, beat period or a beat grid are included in metadata associated with the audio track and retrieved by the audio analysis system 226 or the collection management system 222.

In further examples, the audio analysis system 226 includes or accesses an audio characterization component that generates descriptions and characterizations of audio tracks, and music tracks in particular. Some examples descriptions and characteristics of audio tracks include genre (such as dance, rock, classical, indie, electronica, Christmas, birthday), mood (such as upbeat, somber, chill, party), tempo, instruments played, and so forth. In addition or alternatively, the audio analysis system 226 accesses a music database or song lookup service to obtain or supplement existing metadata associated with a song, such as metadata like track name, artists, album, release date and so forth. The descriptions and characterizations thus generated or accessed can then be used by the collection management system 222 to identify an audio track for use with the video montage.

An artificial intelligence and machine learning system 224 provides a variety of services to different subsystems within the interaction system 100. For example, the artificial intelligence and machine learning system 224 operates with the image processing system 202 and the camera system 204 to analyze images and extract information such as objects, text, or faces. This information can then be used by the image processing system 202 to enhance, filter, or manipulate images. The artificial intelligence and machine learning system 224 includes one or more trained machine learning models that are used to provide requested analysis of images or audio. The machine learning models are trained on collections of images, video or audio having known characteristics that are desired to be identified in new media presented to the artificial intelligence and machine learning system 224 as is known in the art.

In some examples, the artificial intelligence and machine learning system 224 includes image-to-text and video-to-text components that generate descriptions and characterizations of images or videos and of objects or people portrayed in the images or videos. The output of the image-to-text component for each media item can be saved as “tags” or metadata, which can then be used to select or group photos or videos based on common characteristics. Examples of tags include nature scene, still life, birthday party, football game, car, building, cityscape, friends cheering, close-ups, weather, location, time of day, and so forth. In addition to the nature and the contents of images, image styles, contrast, coloring and mood can be determined by the artificial intelligence and machine learning system 224 for use in characterizing and grouping images or video.

Additionally, in the case of video analysis, the artificial intelligence and machine learning system 224 provides scores of the relevance of the contents of the video to the tags or metadata associated with the video. In some examples, These scores vary with the timestamp (location) in the video, such that the collection management system 222 can identify a segment of a video file having a high relevance to the themes or to the tags being used to generate the video montage. A segment of the appropriate length is identified for inclusion in a video montage based on the segment having a higher score than the rest of the video. For example, if the theme of the video montage is cats, and a user-generated video includes both the user's cat and the user's dog, a segment of the video can be identified that scores highly for the presence of the cat alone and that video segment used for the video montage.

In some examples, the artificial intelligence and machine learning system 224 includes a trained audio characterization machine learning model that is accessed by the audio analysis system 226 to generate descriptions and characterizations of audio tracks as described above.

In some examples, provided appropriate privacy permissions are obtained in advance, people are recognized in the media items and characterized based on degree of relationship with the owner of the user system 102, including by relevant group such as degree of relationship to the user of the mobile device 114, common participants in group chats, in groups defined by the user of the mobile device, and so forth.

In some examples, the artificial intelligence and machine learning system 224 is also be used by the augmentation system 206 to generate augmented content and augmented reality experiences, such as adding virtual objects or animations to real-world images. The communication system 208 and messaging system 210 use the artificial intelligence and machine learning system 224 to analyze communication patterns and provide insights into how users interact with each other and with media items stored or created, to provide intelligent message classification and tagging, such as categorizing messages based on sentiment or topic. In some examples, the deletion of media items directly or the deletion of media items from video montages are tracked by the artificial intelligence and machine learning system 224, which is used to generate or refine a machine learning model used to select media items for inclusion in a video montage. For example, if a user consistently deletes video segments in a video montage representing media items of a certain style or genre, or containing certain objects or people, this pattern is used to reduce the likelihood that such media items are included when a new video montage is being created.

In some examples, the artificial intelligence and machine learning system 224 provides chatbot functionality to message interactions 120 between user systems 102 and between a user system 102 and the interaction server system 110. In some examples, the artificial intelligence and machine learning system 224 works with the audio communication system 216 to provide speech recognition and natural language processing capabilities, allowing users to interact with the interaction system 100 using voice commands.

The video generation and editing system 228, in addition to providing general video and photo editing functions such as cropping, trimming and so forth, generates a video montage file based on the data structures that defines how the video montage is to be created. The video generation and editing system 228 generates a video file using the identified audio track and identified media files from the camera roll. The video generation and editing system 228 does this by generating a video segment from each still image identified in the data structure, the video segment having the duration between transitions specified in the data structure, and also extracts a video segment from each video identified by the data structure, starting at the identified start point and again having a duration corresponding to the duration between transitions.

The video generation and editing system 228 also generates and places an attribution icon in the video montage that corresponds to the audio track, which may for example include the title of the audio track and the performing artist. In some examples, the attribution icon is an active icon, with an animated graphic equalizer visual effect, and selection of the attribution icon by user input in some examples permits adding of the audio track to a user's collection or links to additional information about the artist, album, an associated music video, and so forth. The attribution icon is either placed into the video montage at a predefined location such as at the top left of the video frame, placed by the video generation and editing system 228 so as not to overlap objects or people in the video montage that have been identified by the artificial intelligence and machine learning system 224 during selection of the media items for inclusion, or that have been identified after the generation of the video montage itself.

The video generation and editing system 228, in conjunction with the collection management system 222, provides video montage editing capabilities and an associated user interface to the user. For example, when a video montage is being viewed on the mobile device 114, editing options are presented to a user via selection of an “edit” icon or a long press on the touchscreen. The editing options permit the deletion or replacement of a particular media item in the video montage via the presentation by the user interface of corresponding dialog boxes or buttons. Some examples of editing options include a “delete this item” option that enables receipt of user input to delete a particular segment of the video montage, a “replace this item” option that enables receipt of user input to replace an item, and a “move this item” option that enables receipt of user input to move an item to a different location in the video montage. Selection of a “replace this item” option may present the option to choose a replacement, or to allow the system to choose a replacement. In addition, selection of a song title and artist attribution icon can permit the replacement of the audio track, again automatically or based on user selection.

Since the video montage itself is a finished item, in some examples the edits selected by the user do not operate on the video montage itself but are used by the collection management system 222 to update the data structure that was used to create the video montage file itself, based on data acquired during the user inputs specifying the particular edits. For example, a timestamp in the video montage at which an item is to be deleted or replaced can be used by the collection management system 222 to identify the particular media item based on the data in the data structure. For example, a timestamp of 13.3 seconds can be used to identify that the media item to be replaced is the fifth item in a video montage having three second transitions. The collection management system 222 then replaces the identifying data for the corresponding media item with the identifying data for the replacement media item in the data structure. Media items to be deleted or moved are similarly identified, and in the case of the movement of a media item, “move here” user input received at a different time stamp can identify the approximate location to which the media item is to be moved. The exact location can be determined by rounding up or down to the next transition point, and the identifying data for the media item can be moved in the order of the media files from its original location in the data structure to the new location so identified.

After receipt of user input specifying edits to the video montage, receipt of an “update montage” user input will result in a new, updated video montage file being generated by the collection management system 222 and video generation and editing system 228 from the updated data structure, including any adjustment to the transition interval resulting from the selection of a new audio track.

The video generation and editing system 228 also provides user input options to save, delete or forward the video montage as is known for media items.

### Data Architecture

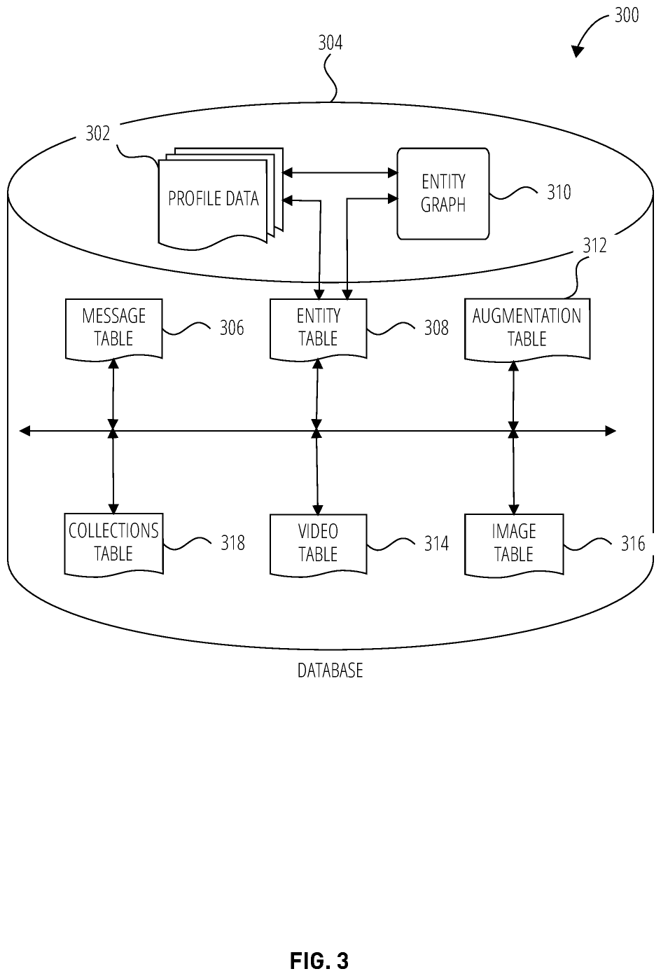

FIG. 3 is a schematic diagram illustrating data structures 300, which may be stored in the database 304 of the interaction server system 110, according to certain examples. While the content of the database 304 is shown to comprise multiple tables, it will be appreciated that the data could be stored in other types of data structures (e.g., as an object-oriented database).

The database 304 includes message data stored within a message table 306. This message data includes, for any particular message, at least message sender data, message recipient (or receiver) data, and a payload. Further details regarding information that may be included in a message, and included within the message data stored in the message table 306, are described below with reference to FIG. 3.

An entity table 308 stores entity data, and is linked (e.g., referentially) to an entity graph 310 and profile data 302. Entities for which records are maintained within the entity table 308 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 310 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 308. Such privacy settings may be applied to all types of relationships within the context of the interaction system 100, or may selectively be applied to certain types of relationships.

The profile data 302 stores multiple types of profile data about a particular entity. The profile data 302 may be selectively used and presented to other users of the interaction system 100 based on privacy settings specified by a particular entity. Where the entity is an individual, the profile data 302 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 304 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 316 includes augmented reality content items (e.g., corresponding to applying “lenses” or augmented reality experiences). An augmented reality content item may be a real-time special effect and sound that may be added to an image or a video.

A collections table 318 stores data regarding collections of messages and associated image, video, or audio data, which are compiled into a collection (e.g., a story or a gallery). The creation of a particular collection may be initiated by a particular user (e.g., each user for which a record is maintained in the entity table 308). A user may create a “personal story” in the form of a collection of content that has been created and sent/broadcast by that user. To this end, the user interface of the interaction client 104 may include an icon that is user-selectable to enable a sending user to add specific content to his or her personal story. The collections table 318 also includes data structures defining video montages, the data structures having been created or modified by the collection management system 222 as described above.

A collection may also constitute a “live story,” which is a collection of content from multiple users that is created manually, automatically, or using a combination of manual and automatic techniques. For example, a “live story” may constitute a curated stream of user-submitted content from various locations and events. Users whose user systems 102 have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 314 stores video data that, in some examples, is associated with messages for which records are maintained within the message table 306. Similarly, the image table 316 stores image data associated with messages for which message data is stored in the entity table 308. The entity table 308 may associate various augmentations from the augmentation table 312 with various images and videos stored in the image table 316 and the video table 314.

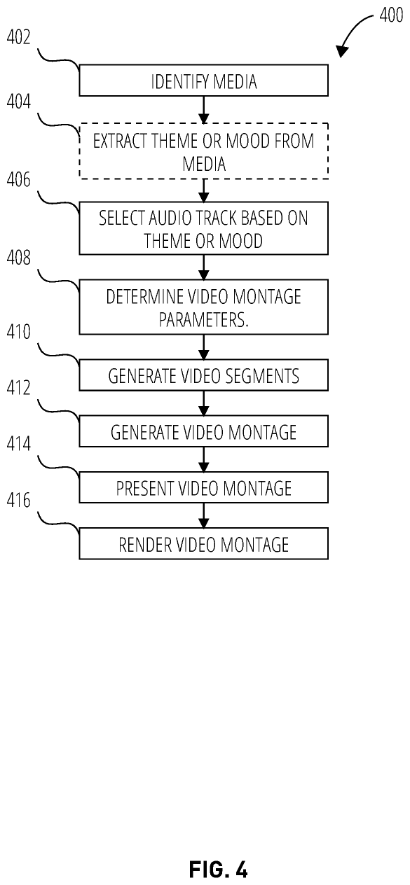

FIG. 4 is a flowchart 400 showing video montage creation operations according to some examples. The operations illustrated in FIG. 4 will typically execute on user system 102 in an application such as an interaction client 104, a video editing application, or a camera application provided with the interaction client 104. Various implementations are of course possible, with some of the operations taking place in interaction servers 124, or with one application calling another application or SDK for required functionality. In one example, the operations are performed jointly between the collection management system 222 and the video generation and editing system 228 embodied in interaction client 104 running on user system 102. For the purposes of clarity, flowchart 400 is discussed herein with reference to such an example.

The method starts at operation 402 with media items being identified by the interaction client 104 for inclusion in a video montage. As discussed above, in some examples the collection management system 222 scans for photos and videos based on the detection of a certain number of new photos or videos that have been captured or stored by a user of the user system 102, based on the user initiating the scanning of one or more videos in an existing collection, or based on themes or moods as discussed above with reference to FIG. 2.

A minimum number and a maximum number of media items are specified by the user or by default, to ensure that any resulting video montage is of a reasonable length. If the minimum number of media items is not met then the flowchart 400 terminates to be run at another time, and if the maximum number of media items is exceeded, a subset of the identified media items equal to the maximum number is selected by the collection management system 222. This can be done randomly, by selecting every nth media item chronologically, or based on a score of the relevance of the image characteristics of the media item to the relevant theme or mood.

In operation 404, if an identifiable theme has not been used to select the media items, a theme or mood is extracted from the selected media items in operation 404 by the collection management system 222 in conjunction with the artificial intelligence and machine learning system 224. This can be done by scanning and characterizing the media items as described above with reference to FIG. 2. Extracted attributes of the media items are be aggregated and ranked in some examples, and a most prevalent or highly ranked attribute found in the of the group of media items used as a theme.

The collection management system 222 then identifies and selects an audio track in operation 406 from a collection of available audio tracks, based on the theme that was used in operation 402 or determined in operation 404, using attributes of the audio tracks that are present in the metadata for the audio tracks or that has been generated by the artificial intelligence and machine learning system 224 as discussed above. The selected audio track thus has a theme parameter that corresponding to a theme parameter of the selected number of media items.

The video montage parameters are then determined from the number of identified media items, the beat period of the audio track, and an initial duration between transitions from one media item in the video montage to the next media item in the video montage. In some examples, the initial duration between transitions is based on the number of media items identified in operation 402, with a shorter duration between transitions for a larger number of media items and a longer duration between transitions for a smaller number of media items, to ensure that the video montage is neither too long nor too short. In some examples, the initial duration value is a default or specified value, or varies between two values to provide variety in the generation of new video montages. For example, the duration can be between two and five seconds, but likely not less than one second or more than ten seconds. The exact duration between transitions is then determined by dividing the initial duration by the beat period, rounding up, and then multiplying the rounded up value by the beat period to determine a final duration between transitions. The video montage parameters are then saved into a new data structure that defines and is associated with the video montage.

Video segments having a duration equal to the determined final duration between the transitions are then generated by the video generation and editing system 228 in operation 410. This involves creating a video segment of the correct length from each still image, and extracting a video segment of the correct length from each video file. As discussed above, the portion of the video file that is extracted is based on the relevance of that portion to the theme or mood, may be a central portion of the video, or some other characteristic.

The video montage is then generated by the collection management system 222 and the video generation and editing system 228 in operation 412. This is done based on the video montage parameters generated in operation 408 and stored in the data structure, and involves adding the individual video segments together, and adding the selected audio track to the resulting video montage with an initial beat of the audio track, which may or may not be the first beat, coinciding with the start of the video file. In some examples, the video segment includes visual effects, such as zooming or panning, or the generation and display of AR or other image manipulations or effects that are applied to the original video or still image, to provide a more dynamic video segment, in particular for video segments generated from still images.

In some examples, An attribution icon for the audio track is added to the video montage, positioned in the video frame as described above. In some examples, additional visual or audio effects are applied to the individual video segments or the video montage.

In one example, the order in which the media items are listed in the data structure, and thus included in the video montage, is chronological based on the time and date of capture. In other examples, the media items are listed in a different order, such as by grouping items based on relevance to a theme, based on how similar media items are to other selected media items to provide consistency, or based on how different media items are from other media items to provide variety within the video montage.

The interaction client 104 then presents the video montage in a user interface, for selection and viewing by the user of the mobile device 114 in operation 414. Upon receipt of user input to view the video montage, the interaction client 104 renders the video montage using the display of and audio speakers associated with the mobile device 114 in operation 416, to play back the video montage.

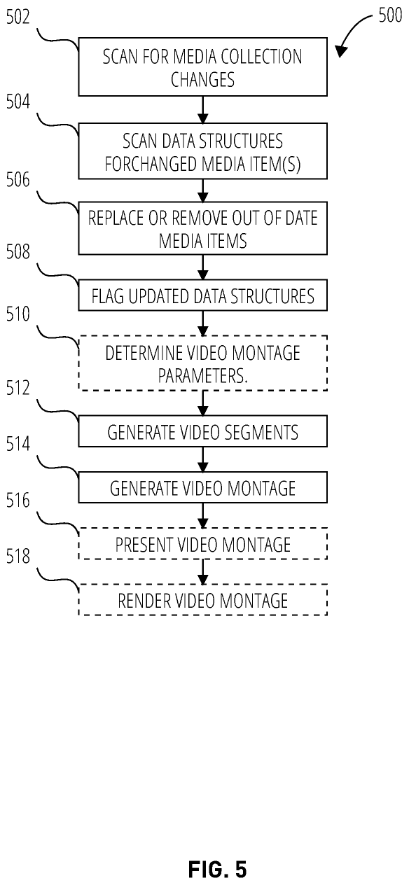

FIG. 5 is a flowchart 500 showing video montage updating and editing operations according to some examples. The operations illustrated in FIG. 5 will typically execute on user system 102 in an application such an interaction client 104, a video editing application, or a camera application provided with the interaction client 104. Various implementations are of course possible, with some of the operations taking place in interaction servers 124, or with one application calling another application or SDK for required functionality. In one example, the operations are performed jointly between the collection management system 222 and the video generation and editing system 228 embodied in interaction client 104 running on user system 102. For the purposes of clarity, flowchart 500 is discussed herein with reference to such an example.

The method starts at operation 502 with the interaction client 104 scanning the camera roll or other media items collection for changes to the media items in the collection. The changes may for example be the deletion of an item in the camera roll, or a change in attributes (such as file size, image orientation, or last-modified date) of a media file, which indicates that the media item has been modified by operations such as cropping, rotating, or the application of visual effects. Media items that have been deleted or changed are identified. The video-montage-defining data structures are scanned by the collection management system 222 to determine if an out of date media item is found in a video montage, in operation 504.

In operation 506, media items that have been deleted from the camera roll are removed from each data structure in which they are found. In some cases a deleted media item is replaced in each data structure in which the deleted item was found, for example with an unused item in the original group of items previously determined in operation 402, such as leftover items when the maximum number of items to be used in the video montage was exceeded in operation 402. In other cases, the deleted item data are simply removed from each data structure in which the deleted item was found. The data structure is then flagged as being an updated data structure in operation 508.

Similarly, in operation 506, the collection management system 222 scans the data structures for the presence of any out of date media items, based on a “last modified date” that is later than the date of creation of the video montage or the date of last modification of the video montage, and replaces any changed metadata associated with the outdated media item with updated metadata for that media item. If not already flagged as such, the data structure is then flagged as being an updated data structure in operation 508.

Operations 510 to operation 514 and optionally operations 516 to 518 are then performed for each of the updated data structures, as follows.

The video montage parameters for an updated (flagged) data structure are then determined in operation 510 as described above with reference to operation 408, if required. Unless the audio track has been changed, or unless the interval between transitions has changed based on the number of media items changing due to the removal of a deleted media item, the basic parameters of the video montage, such as the interval between transitions, will not change.

Video segments having a duration equal to the determined final duration between the transitions are then generated by the video generation and editing system 228 in operation 512 for each of the new or updated media items, or for all of the media items if the duration between transitions has changed, as discussed above with reference to operation 410.

An updated video montage is then generated by the collection management system 222 and the video generation and editing system 228 in operation 514. As described above with reference to operation 412, this is done based on the video montage parameters generated in operation 510 and stored in the data structure, and involves adding the individual segments together, and adding the selected audio track to the resulting video with an initial beat of the audio track, which may or may not be the first beat, coinciding with the start of the video file. An attribution icon for the audio track is also added to the video montage, positioned in the video frame as described above.

The interaction client 104 then presents the video montage in a user interface, for selection and viewing by the user of the mobile device 114. Upon receipt of user input to view the video montage, the interaction client 104 renders the video montage using the display of and audio speakers associated with the mobile device 114, to play back the video montage.

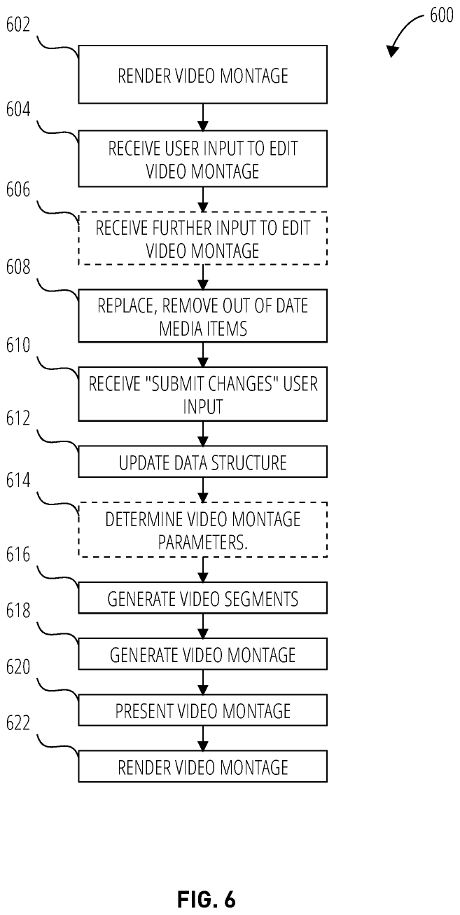

FIG. 6 is a flowchart 600 showing video montage updating and editing operations according to some examples. The operations illustrated in FIG. 6 will typically execute on user system 102 in an application such an interaction client 104, a video editing application, or a camera application provided with the interaction client 104. Various implementations are of course possible, with some of the operations taking place in interaction servers 124, or with one application calling another application or SDK for required functionality. In one example, the operations are performed jointly between the collection management system 222 and the video generation and editing system 228 embodied in interaction client 104 running on user system 102. For the purposes of clarity, flowchart 600 is discussed herein with reference to such an example.

The method starts at operation 602 with the interaction client 104 rendering the video montage on the screen of the mobile device 114. In operation 604, user input to edit the video montage is received by the interaction client 104. This may for example be by receipt of a pause user input followed by selection of an “edit” icon, followed by selection of a remove option, a replace option or a move option. The timestamp in the video at the current location is captured, which is used by the collection management system 222 to identify the media item that is to be removed. Further editing user input is then received in operation 606 depending on whether further input is required, or further editing is desired by the user of the mobile device 114.

For example if a “move” user input is received, user input scrolling to a new location in the video montage will be received, at which point user input selecting that location for editing will be received, such as by selection of an option such as “move here,” “move to before,” or “move to after.” The timestamp in the video at the new location is captured, which is used by the collection management system 222 to identify the media item before or after which the to-be-moved media item is to be placed. As mentioned previously, if the selection is “move here,” the timestamp will be rounded up or down to the nearest transition to identify the location to which the selected media item is to be moved.

If the “replace” option has been selected, a “choose for me” or “I'll choose” option can be presented. Selection of the “I'll choose” option will open the camera roll user interface to permit selection of a replacement media item.

The further inputs received in operation 606 can include user inputs for an additional remove, replace or move, which are handled as described above. Upon receipt of a “submit changes” user input in operation 610, the collection management system 222 updates the data structure corresponding to the video montage being edited with all of the changes received from the user in operations 606 and 608, in operation 612. If “choose for me” has been selected as the “replace” option, the collection management system 222 replaces the data for the removed media item as described above with reference to operation 506. If no unused media items are available from the original search, the original search parameters may be broadened to identify additional media items to replace the original media item flagged for replacement.

The further inputs received in operation 606 can include selection of an option to replace the audio track. In such a case, a “choose for me” or “I'll choose” option can be presented. Selection of the “I'll choose” option will open a music collection user interface to permit selection of a replacement audio track. Selection of “choose for me” will cause the collection management system 222 to search for an alternative audio track having the same or similar characteristics as the originally-selected audio track, as described above with reference to operation 406.

The video montage parameters for the updated data structure are determined in operation 614 as described above with reference to operation 408, if required. Unless the audio track has been changed, or unless the interval between transitions has changed based on the number of media items changing due to the removal of a deleted media item, the basic parameters of the video montage, such as the interval between transitions, will not change.

Video segments having a duration equal to the determined final duration between the transitions are then generated by the video generation and editing system 228 in operation 616 for each of the new media items, or for all of the media items if the duration between transitions has changed based for example on the beat period of the new audio track, as discussed above with reference to operation 410.

An updated video montage is then generated by the collection management system 222 and the video generation and editing system 228 in operation 618. As described above with reference to operation 412, this is done based on the video montage parameters generated in operation 614 and stored in the data structure, and involves adding the individual segments together, and adding the original or new audio track to the resulting video with an initial beat of the audio track, which may or may not be the first beat, coinciding with the start of the video file. An attribution icon for the audio track is also added to the video montage, positioned in the video frame as described above.

The interaction client 104 then presents the video montage in a user interface, for selection and viewing by the user of the mobile device 114 in operation 620. Upon receipt of user input to view the video montage, the interaction client 104 renders the video montage using the display of and audio speakers associated with the mobile device 114 in operation 622, to play back the video montage.

Various examples are contemplated.

Example 1 is a system comprising: at least one processor; at least one memory component storing instructions that, when executed by the at least one processor, cause the at least one processor to perform operations comprising: selecting a number of media items for use in a video montage of the media items; identifying an audio track having a theme parameter corresponding to a theme parameter of the number of media items; and generating a video montage incorporating the media items and the audio track.

In Example 2, the subject matter of Example 1 includes, wherein selecting the number of media items for use in the video montage comprises: scanning a collection of media items for media items having the theme parameter.

In Example 3, the subject matter of Example 2 includes, wherein the theme parameter comprises a descriptor of an image augmentation.

In Example 4, the subject matter of Examples 1-3 includes, wherein the media items are selected based on a particular time period or based on recency of the media items, and wherein the theme parameter is determined by performing a visual analysis of the number of media items.

In Example 5, the subject matter of Examples 1-4 includes, generating a data structure specifying an identity and order of the media items and a start location of the audio track, wherein generating the video montage comprises: generating individual video segments from each media item in the number of media items; and assembling the individual video segments into the video montage based on an order specified in the data structure.

In Example 6, the subject matter of Example 5 includes, causing display of the video montage; receiving user input to remove or replace a particular media item in the video montage; updating the data structure to remove or replace the particular media item in the video montage; and regenerating the video montage based on the updated data structure.

In Example 7, the subject matter of Examples 5-6 includes, determining that a particular media item used in a video montage has been deleted from a media collection; updating the data structure to remove or replace the particular media item in the video montage; and regenerating the video montage based on the updated data structure.

Example 8 is a method of generating a video montage, performed by one or more processors, the method comprising: selecting a number of media items for use in a video montage of the media items; identifying an audio track having a theme parameter corresponding to a theme parameter of the number of media items; and generating a video montage incorporating the media items and the audio track.

In Example 9, the subject matter of Example 8 includes, wherein selecting the number of media items for use in the video montage comprises: scanning a collection of media items for media items having the theme parameter.

In Example 10, the subject matter of Example 9 includes, wherein the theme parameter comprises a descriptor of an image augmentation.

In Example 11, the subject matter of Examples 8-10 includes, wherein the media items are selected based on a particular time period or based on recency of the media items, and wherein the theme parameter is determined by performing a visual analysis of the number of media items.

In Example 12, the subject matter of Examples 8-11 includes, generating a data structure specifying an identity and order of the media items and a start location of the audio track, wherein generating the video montage comprises: generating individual video segments from each media item in the number of media items; and assembling the individual video segments into the video montage based on an order specified in the data structure.

In Example 13, the subject matter of Example 12 includes, causing display of the video montage; receiving user input to remove or replace a particular media item in the video montage; updating the data structure to remove or replace the particular media item in the video montage; and regenerating the video montage based on the updated data structure.

In Example 14, the subject matter of Examples 12-13 includes, determining that a particular media item used in a video montage has been deleted from a media collection; updating the data structure to remove or replace the particular media item in the video montage; and regenerating the video montage based on the updated data structure.

Example 15 is a non-transitory computer-readable storage medium, the computer-readable storage medium including instructions that when executed by one or more processors, cause the one or more processors to perform operations for generating a video montage, the operations comprising: selecting a number of media items for use in a video montage of the media items; identifying an audio track having a theme parameter corresponding to a theme parameter of the number of media items; and generating a video montage incorporating the media items and the audio track.

In Example 16, the subject matter of Example 15 includes, wherein selecting the number of media items for use in the video montage comprises: scanning a collection of media items for media items having the theme parameter.

In Example 17, the subject matter of Example 16 includes, wherein the theme parameter comprises a descriptor of an image augmentation.

In Example 18, the subject matter of Examples 15-17 includes, wherein the media items are selected based on a particular time period or based on recency of the media items, and wherein the theme parameter is determined by performing a visual analysis of the number of media items.

In Example 19, the subject matter of Examples 15-18 includes, generating a data structure specifying an identity and order of the media items and a start location of the audio track, wherein generating the video montage comprises: generating individual video segments from each media item in the number of media items; and assembling the individual video segments into the video montage based on an order specified in the data structure.

In Example 20, the subject matter of Example 19 includes, determining that a particular media item used in a video montage has been deleted from a media collection; updating the data structure to remove or replace the particular media item in the video montage; and regenerating the video montage based on the updated data structure.

Example 21 is at least one machine-readable medium including instructions that, when executed by processing circuitry, cause the processing circuitry to perform operations to implement of any of Examples 1-20. Example 22 is an apparatus comprising means to implement of any of Examples 1-20. Example 23 is a system to implement of any of Examples 1-20. Example 24 is a method to implement of any of Examples 1-20.

### Machine Architecture

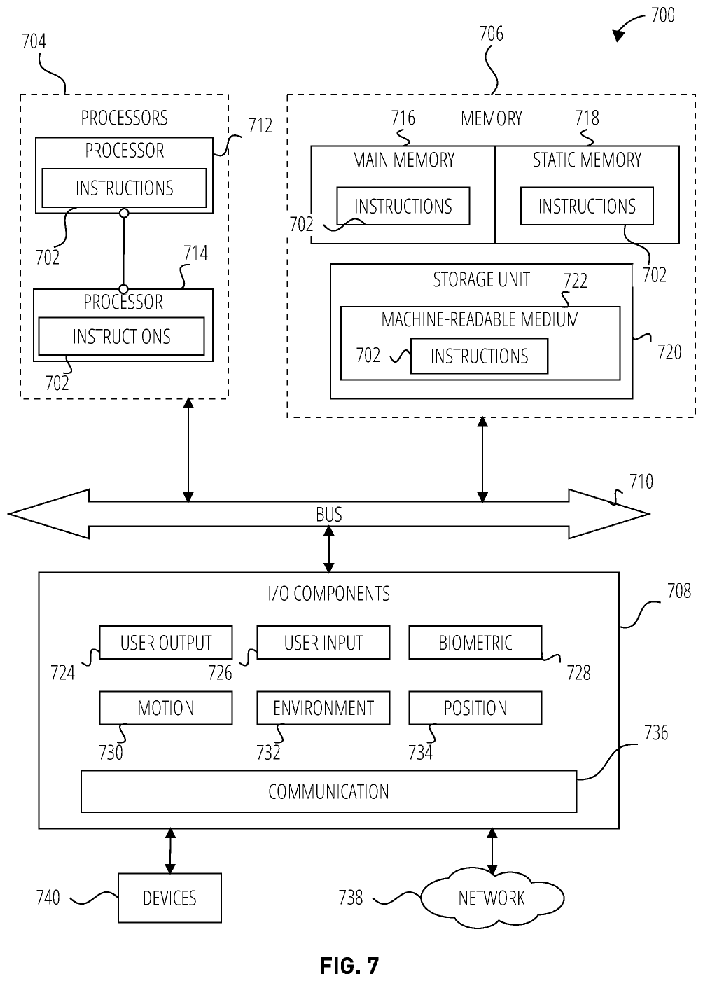

FIG. 7 is a diagrammatic representation of the machine 700 within which instructions 702 (e.g., software, a program, an application, an applet, an app, or other executable code) for causing the machine 700 to perform any one or more of the methodologies discussed herein may be executed. For example, the instructions 702 may cause the machine 700 to execute any one or more of the methods described herein. The instructions 702 transform the general, non-programmed machine 700 into a particular machine 700 programmed to carry out the described and illustrated functions in the manner described. The machine 700 may operate as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 702, sequentially or otherwise, that specify actions to be taken by the machine 700. Further, while a single machine 700 is illustrated, the term “machine” shall also be taken to include a collection of machines that individually or jointly execute the instructions 702 to perform any one or more of the methodologies discussed herein. The machine 700, for example, may comprise the user system 102 or any one of multiple server devices forming part of the interaction server system 110. In some examples, the machine 700 may also comprise both client and server systems, with certain operations of a particular method or algorithm being performed on the server-side and with certain operations of the particular method or algorithm being performed on the client-side.

The machine 700 may include processors 704, memory 706, and input/output I/O components 708, which may be configured to communicate with each other via a bus 710. In an example, the processors 704 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 712 and a processor 714 that execute the instructions 702. The term “processor” is intended to include multi-core processors that may comprise two or more independent processors (sometimes referred to as “cores”) that may execute instructions contemporaneously. Although FIG. 7 shows multiple processors 704, the machine 700 may include a single processor with a single-core, a single processor with multiple cores (e.g., a multi-core processor), multiple processors with a single core, multiple processors with multiples cores, or any combination thereof.

The memory 706 includes a main memory 716, a static memory 718, and a storage unit 720, both accessible to the processors 704 via the bus 710. The main memory 706, the static memory 718, and storage unit 720 store the instructions 702 embodying any one or more of the methodologies or functions described herein. The instructions 702 may also reside, completely or partially, within the main memory 716, within the static memory 718, within machine-readable medium 722 within the storage unit 720, within at least one of the processors 704 (e.g., within the processor's cache memory), or any suitable combination thereof, during execution thereof by the machine 700.

The I/O components 708 may include a wide variety of components to receive input, provide output, produce output, transmit information, exchange information, capture measurements, and so on. The specific I/O components 708 that are included in a particular machine will depend on the type of machine. For example, portable machines such as mobile phones may include a touch input device or other such input mechanisms, while a headless server machine will likely not include such a touch input device. It will be appreciated that the I/O components 708 may include many other components that are not shown in FIG. 7. In various examples, the I/O components 708 may include user output components 724 and user input components 726. The user output components 724 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 726 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 708 may include biometric components 728, motion components 730, environmental components 732, or position components 734, among a wide array of other components. For example, the biometric components 728 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 730 include acceleration sensor components (e.g., accelerometer), gravitation sensor components, rotation sensor components (e.g., gyroscope).

The environmental components 732 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 734 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 708 further include communication components 736 operable to couple the machine 700 to a network 738 or devices 740 via respective coupling or connections. For example, the communication components 736 may include a network interface component or another suitable device to interface with the network 738. In further examples, the communication components 736 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 740 may be another machine or any of a wide variety of peripheral devices (e.g., a peripheral device coupled via a USB).

Moreover, the communication components 736 may detect identifiers or include components operable to detect identifiers. For example, the communication components 736 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 736, such as location via Internet Protocol (IP) geolocation, location via Wi-Fi® signal triangulation, location via detecting an NFC beacon signal that may indicate a particular location, and so forth.

The various memories (e.g., main memory 716, static memory 718, and memory of the processors 704) and storage unit 720 may store one or more sets of instructions and data structures (e.g., software) embodying or used by any one or more of the methodologies or functions described herein. These instructions (e.g., the instructions 702), when executed by processors 704, cause various operations to implement the disclosed examples.

The instructions 702 may be transmitted or received over the network 738, using a transmission medium, via a network interface device (e.g., a network interface component included in the communication components 736) and using any one of several well-known transfer protocols (e.g., hypertext transfer protocol (HTTP)). Similarly, the instructions 702 may be transmitted or received using a transmission medium via a coupling (e.g., a peer-to-peer coupling) to the devices 740.

### Software Architecture

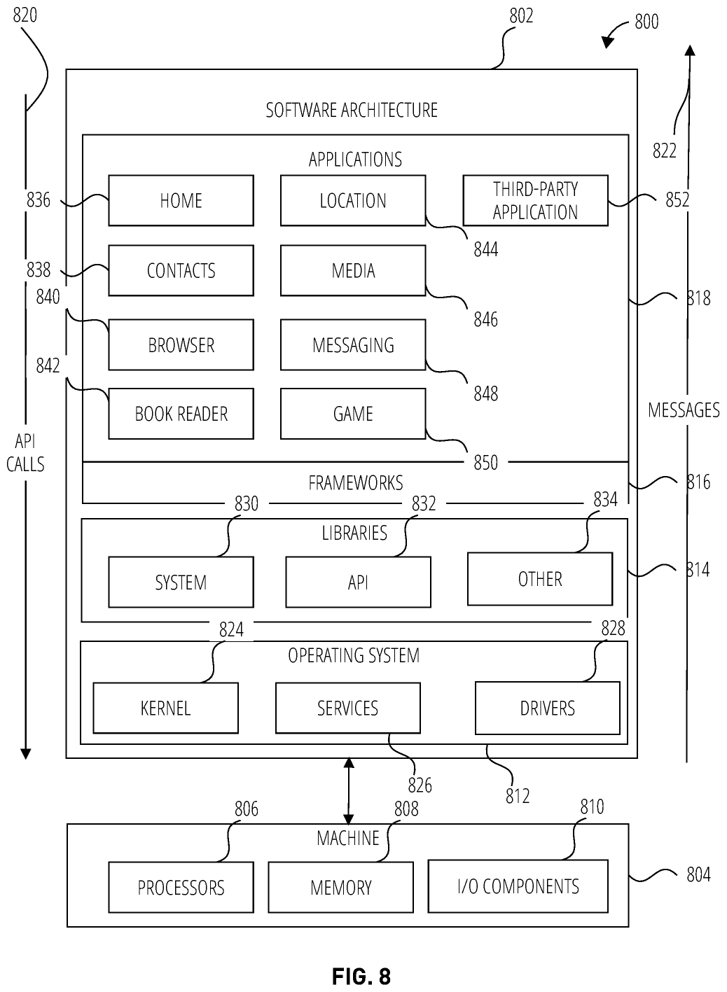

FIG. 8 is a block diagram 800 illustrating a software architecture 802, which can be installed on any one or more of the devices described herein. The software architecture 802 is supported by hardware such as a machine 804 that includes processors 806, memory 808, and I/O components 810. In this example, the software architecture 802 can be conceptualized as a stack of layers, where each layer provides a particular functionality. The software architecture 802 includes layers such as an operating system 812, libraries 814, frameworks 816, and applications 818. Operationally, the applications 818 invoke API calls 820 through the software stack and receive messages 822 in response to the API calls 820.

The operating system 812 manages hardware resources and provides common services. The operating system 812 includes, for example, a kernel 824, services 826, and drivers 828. The kernel 824 acts as an abstraction layer between the hardware and the other software layers. For example, the kernel 824 provides memory management, processor management (e.g., scheduling), component management, networking, and security settings, among other functionalities. The services 826 can provide other common services for the other software layers. The drivers 828 are responsible for controlling or interfacing with the underlying hardware. For instance, the drivers 828 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 814 provide a common low-level infrastructure used by the applications 818. The libraries 814 can include system libraries 830 (e.g., C standard library) that provide functions such as memory allocation functions, string manipulation functions, mathematic functions, and the like. In addition, the libraries 814 can include API libraries 832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 814 can also include a wide variety of other libraries 834 to provide many other APIs to the applications 818.

The frameworks 816 provide a common high-level infrastructure that is used by the applications 818. For example, the frameworks 816 provide various graphical user interface (GUI) functions, high-level resource management, and high-level location services. The frameworks 816 can provide a broad spectrum of other APIs that can be used by the applications 818, some of which may be specific to a particular operating system or platform.

In an example, the applications 818 may include a home application 836, a contacts application 838, a browser application 840, a book reader application 842, a location application 844, a media application 846, a messaging application 848, a game application 850, and a broad assortment of other applications such as a third-party application 852. The applications 818 are programs that execute functions defined in the programs. Various programming languages can be employed to create one or more of the applications 818, structured in a variety of manners, such as object-oriented programming languages (e.g., Objective-C, Java, or C++) or procedural programming languages (e.g., C or assembly language). In a specific example, the third-party application 852 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 852 can invoke the API calls 820 provided by the operating system 812 to facilitate functionalities described herein.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“User device” or “user system” refers, for example, to any machine that interfaces to a communications network to obtain resources from one or more server systems or other user devices. A user device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action or interaction on the user device, including an interaction with other users or computer systems.

What is claimed is:

1. A system comprising:
at least one processor;
at least one memory component storing instructions that, when executed by the at least one processor, cause the at least one processor to perform operations comprising:
selecting a number of media items for use in a video montage comprising the number of media items;
identifying an audio track having a theme parameter corresponding to a theme parameter of the number of media items; and
generating a video montage incorporating the number of media items and the audio track.

2. The system of claim 1, wherein selecting the number of media items for use in the video montage comprises:
scanning a collection of media items for media items having the theme parameter.

3. The system of claim 2, wherein the theme parameter comprises a descriptor of an image augmentation.

4. The system of claim 1, wherein the number of media items are selected based on a particular time period or based on recency of the number of media items, and wherein the theme parameter is determined by performing a visual analysis of the number of media items.

5. The system of claim 1, further comprising:
generating a data structure specifying an identity and order of the number of media items and a start location of the audio track, wherein generating the video montage comprises:
generating individual video segments from each media item in the number of media items; and
assembling the individual video segments into the video montage based on an order specified in the data structure.

6. The system of claim 5, further comprising:
causing display of the video montage;
receiving user input to remove or replace a particular media item in the video montage;
updating the data structure to remove or replace the particular media item in the video montage; and
regenerating the video montage based on the updated data structure.

7. The system of claim 5, further comprising:
determining that a particular media item used in a video montage has been deleted from a media collection;
updating the data structure to remove or replace the particular media item in the video montage; and
regenerating the video montage based on the updated data structure.

8. A method of generating a video montage, performed by one or more processors, the method comprising:
selecting a number of media items for use in a video montage comprising the number of media items;
identifying an audio track having a theme parameter corresponding to a theme parameter of the number of media items; and
generating a video montage incorporating the number of media items and the audio track.

9. The method of claim 8, wherein selecting the number of media items for use in the video montage comprises:
scanning a collection of media items for media items having the theme parameter.

10. The method of claim 9, wherein the theme parameter comprises a descriptor of an image augmentation.

11. The method of claim 8, wherein the number of media items are selected based on a particular time period or based on recency of the number of media items, and wherein the theme parameter is determined by performing a visual analysis of the number of media items.

12. The method of claim 8, further comprising:
generating a data structure specifying an identity and order of the number of media items and a start location of the audio track, wherein generating the video montage comprises:
generating individual video segments from each media item in the number of media items; and
assembling the individual video segments into the video montage based on an order specified in the data structure.

13. The method of claim 12, further comprising:
causing display of the video montage; receiving user input to remove or replace a particular media item in the video montage;
updating the data structure to remove or replace the particular media item in the video montage; and
regenerating the video montage based on the updated data structure.

14. The method of claim 12, further comprising:
determining that a particular media item used in a video montage has been deleted from a media collection;
updating the data structure to remove or replace the particular media item in the video montage; and
regenerating the video montage based on the updated data structure.

15. A non-transitory computer-readable storage medium, the computer-readable storage medium including instructions that when executed by one or more processors, cause the one or more processors to perform operations for generating a video montage, the operations comprising:
selecting a number of media items for use in a video montage comprising the number of media items;
identifying an audio track having a theme parameter corresponding to a theme parameter of the number of media items; and
generating a video montage incorporating the number of media items and the audio track.

16. The non-transitory computer-readable storage medium of claim 15, wherein selecting the number of media items for use in the video montage comprises:
scanning a collection of media items for media items having the theme parameter.

17. The non-transitory computer-readable storage medium of claim 16, wherein the theme parameter comprises a descriptor of an image augmentation.

18. The non-transitory computer-readable storage medium of claim 15, wherein the number of media items are selected based on a particular time period or based on recency of the number of media items, and wherein the theme parameter is determined by performing a visual analysis of the number of media items.

19. The non-transitory computer-readable storage medium of claim 15, further comprising:
generating a data structure specifying an identity and order of the number of media items and a start location of the audio track, wherein generating the video montage comprises:
generating individual video segments from each media item in the number of media items; and
assembling the individual video segments into the video montage based on an order specified in the data structure.

20. The non-transitory computer-readable storage medium of claim 19, further comprising:
determining that a particular media item used in a video montage has been deleted from a media collection;
updating the data structure to remove or replace the particular media item in the video montage; and
regenerating the video montage based on the updated data structure.
